(19) United States
(12) Patent Application Publication
(10) Pub. No.: US 2021/0388879 A1
(43) Pub. Date: Dec. 16, 2021

(54) METHOD FOR OPERATING A COMBINED CLUTCH- AND BRAKE DEVICE OF A PUNCH PRESS

(71) Applicant: Bruderer AG, Frasnacht (CH)

(72) Inventors: Josef Thomas Hafner, Rorschacherberg (CH); Daniel Straub, Dozwil (CH)

(21) Appl. No.: 17/287,183

(22) PCT Filed: Oct. 22, 2018
(86) PCT No.: PCT/CH2018/000042

§ 371 Date: Apr. 21, 2021

(51) Int. Cl. F16D 67/02; F16D 55/22; F16D 65/853; F16D 65/00; B30B 15/10; B30B 15/12; B21D 22/02; G10K 11/16

(52) U.S. Cl. CPC F16D 67/02; F16D 55/22; F16D 65/853; F16D 65/0006; F16D 2055/0033; B30B 15/10; B30B 15/12; B21D 22/02; G10K 11/161; F16D 65/0081

(57) ABSTRACT

The invention relates to a method for operating a combined clutch and brake device (5) of a punch press (1) equipped with dry friction linings (7, 8). Thereby, the friction linings (7, 8) are arranged in a chamber (R) which is sealed off from the environment of the punch press (1), and which is filled with a dry and oil-free gaseous medium, in particular with dry oil-free air. This effectively prevents moisture and oil mist from entering the region of the friction linings from the environment of the press, and a constant friction coefficient can be achieved over the mechanical service life of the friction linings.

### CROSS-REFERENCE TO RELATED APPLICATION

This application is a National Stage application of International Patent Application No. PCT/CH2018/000042, filed on Oct. 22, 2018, which is hereby incorporated by reference in its entirety.

### TECHNICAL FIELD

The present invention relates to a method for operating a combined clutch and brake device of a punch press equipped with dry friction linings, a combined clutch and brake device for carrying out the method, and a punch press with the clutch and brake device according to the preambles of the independent patent claims.

### BACKGROUND

Dry-running clutch-brake combinations have become established in high-performance automatic punch presses. These transmit their torque via friction by means of organic friction linings. The actuating pistons in the clutch and brake are supplied with compressed air via special safety valves, which usually contains moisture and is enriched with oil. During shifting, this moisty and oily air is released into the environment of the punch press. Additional oil is released into the ambient air by spraying the to be processed strip material with cutting oil. The air that is thus enriched with oil and water vapor comes into contact with the friction linings of the clutch-brake combination during operation, causing them to become increasingly oily with increasing operating time and worsening the clutch and brake torque until replacement or cleaning of the linings is required. Since the linings are usually not subject to any substantial wear that would require regular replacement, the costs and downtimes incurred by replacing or cleaning the oily linings are particularly unpleasant.

### SUMMARY

Therefore, the objective here is to provide a technical solution that does not have the disadvantages of the prior art described above or at least partially avoids them.

This objective is achieved by the subject-matter of the independent patent claims.

According to these, a first aspect of the invention relates to a method for operating a combined clutch and brake device of a punch press equipped with dry friction linings. According to the invention, the friction linings of the clutch and brake device are thereby arranged in a chamber sealed off from the environment of the punch press, e.g. in a housing surrounding the clutch and brake device, which is filled with a gaseous and essentially dry and oil-free medium, e.g. with dry oil-free air. This effectively prevents moisture and oil mist from entering the region of the friction linings from the environment of the press, and a constant friction coefficient can be achieved over the mechanical service life of the friction linings.

Preferably, the chamber is pressurized with the gaseous medium under overpressure during the intended operation and even more preferably also during any putative operating breaks. In this way, in the event of leaks, no foreign medium possibly contaminated with oil and/or moisture can enter the chamber and possibly change the friction coefficient of the friction linings.

In a preferred embodiment of the method, the gaseous medium is set in motion in the chamber during the intended operation, e.g. circulated in the chamber by means of forced convection. This allows heat to be transported away from the friction linings to the boundaries of the chamber and to be transferred to them. Also a uniform temperature distribution in the chamber can be achieved thereby, which is particularly advantageous if the temperature of the gaseous medium is monitored and used to control certain interventions, e.g. to control the replacement of heated gaseous medium in the chamber by new, cooler gaseous medium when a certain threshold temperature is reached or to trigger an emergency stop if there is a risk of overheating of the friction linings.

In another preferred embodiment of the method, gaseous medium is supplied to and discharged from the chamber continuously, intermittently, or under specific operating conditions.

For example, it is envisaged that a certain amount of gaseous medium permanently flows out of the chamber, e.g. into the environment, via one or more discharge openings with a small flow cross-section and is replaced by newly supplied medium, so that there is a permanent exchange of medium in the chamber and thus a concomitant removal of heat from the chamber. Thereby, the discharge openings should be dimensioned in such a way that, if possible, only as much medium flows out as is necessary to transport away the heat generated or to maintain a desired medium temperature in the chamber, respectively. The discharge openings can be designed with fixed or variable flow cross-sections.

It is also envisaged that a complete or partial medium exchange or flushing of the chamber with fresh dry and oil-free gaseous medium, respectively, is carried out intermittently, e.g. every 5 minutes during the intended operation, or only if certain operating conditions are present, e.g. if it is necessary to stop and restart several times with a very high stroke rate or if it is necessary to inch for a long time in setup mode. It can also be envisaged, for example, that a medium exchange is initiated in a temperature-controlled manner, e.g. if a certain temperature is reached in the chamber.

In a preferred embodiment of the method, in which dry and oil-free gaseous medium is supplied to the chamber and discharged from the chamber permanently, intermittently or under specific operating conditions, the discharged medium is released into the environment of the punch press. In this way, an extremely simple method becomes possible which requires a minimum of technical equipment.

Thereby, it is in a first variant preferred that the dry and oil-free gaseous medium supplied to the chamber is air, which is drawn in from the environment of the punch press, cleaned, dried and/or de-oiled by means of a treatment device and then supplied to the chamber. In this way, any quantities of dry and oil-free gaseous medium can be made available in a simple manner.

In a second variant, it is preferred that the dry and oil-free gaseous-medium supplied to the chamber is supplied to the chamber from a reservoir. This has the advantage that a particular gas atmosphere can specifically be created in the chamber, e.g. of nitrogen or helium.

In another preferred embodiment of the method, the chamber is part of a circuit in which, during the intended operation, the gaseous medium which is discharged from the chamber is subjected to a treatment and then re-supplied to the chamber.

Preferably, the treatment includes a cooling of the medium. Other preferred treatments include dehumidifying/de-oiling of the medium and/or a cleaning of the medium, e.g. filtering.

Such methods with closed medium circuits have the advantage that with very small quantities of gaseous medium a constant medium environment for the friction linings in terms of both medium temperature as well as medium composition can be created, so that the same friction conditions are always present at all times.

A second aspect of the invention relates to a combined clutch and brake device for carrying out the method according to the first aspect of the invention, which is equipped with dry friction linings for transmitting the drive and brake torques.

The friction linings of the clutch and brake device are arranged in a chamber which is sealed off from the environment of the punch press, e.g. in a housing surrounding the clutch and brake device, which during the intended operation is filled with a gaseous and essentially dry and oil-free medium, e.g. with dry oil-free air. Thereby, an entry of moisture and oil mist into the region of the friction linings from the environment of the press is effectively prevented and thus a constant friction coefficient is enabled over the mechanical service life of the friction linings.

Preferably, the clutch and brake device is designed in such a way that the chamber can be pressurized with the gaseous medium at an overpressure during the intended operation, and even more preferably also during any putative operating breaks. In this way, in the event of leakages, no foreign medium possibly contaminated with oil and/or moisture can enter the chamber and possibly change the friction coefficient of the friction linings.

In a preferred embodiment, the clutch and brake device has means, e.g. internal fan blades, by means of which the gaseous medium can be set in motion in the chamber during the intended operation, e.g. can be circulated in the chamber by means of forced convection. In this way, heat can be transported away from the friction linings to the boundaries of the chamber and dissipated to them. Also a uniform temperature distribution in the chamber can be achieved thereby, which is particularly advantageous if the medium temperature is monitored and used to control certain interventions, e.g. to control a replacement of gaseous medium heated in the chamber by new, cooler gaseous medium when a certain threshold temperature is reached or to trigger an emergency stop if there is a risk of overheating of the friction linings.

In a further preferred embodiment, the chamber has supply and discharge openings through which, during the intended operation, gaseous-medium can be supplied to and discharged from the chamber permanently, intermittently or under certain operating conditions.

For example, it is envisaged that the chamber has one or more discharge openings through which, during the intended operation, a certain amount of gaseous medium permanently flows out of the chamber, e.g. into the environment, and is replaced by newly supplied medium, such that that there is a permanent exchange of medium in the chamber and thus a concomitant removal of heat from the chamber. The discharge openings are preferably dimensioned in such a way that only as much medium flows out as is necessary to remove the heat generated or to maintain a desired medium temperature in the chamber, respectively. The discharge openings can have fixed or variable flow cross-sections.

Thereby, in a first variant of this embodiment, it is preferred that the clutch and brake device comprises an air treatment device by means of which air can be drawn in from the environment of the punch press during the intended operation, cleaned, dried and/or de-oiled, and then supplied to the chamber. In this way, any desired quantities of dry and oil-free gaseous medium can be made available in a simple manner.

In a second variant of this embodiment, it is preferred that the clutch and brake device comprises a reservoir for the gaseous and essentially dry and oil-free medium, from which this medium can be supplied to the chamber. This has the advantage that a specific gas atmosphere can be created in the chamber, e.g. of nitrogen or helium.

In a third variant of this embodiment, it is preferred that the chamber is part of a circuit in which the gaseous medium is circulated during the intended operation.

Advantageously, means are arranged in the circuit for treating the gaseous medium circulated therein during the intended operation, preferably for cooling, dehumidifying and/or de-oiling of the gaseous medium circulated therein.

It is also preferred that cleaning and/or filtering devices are present in the circuit for cleaning and/or filtering the gaseous medium circulated therein during the intended operation.

Such embodiments of the clutch and brake device according to the invention with closed medium circuits have the advantage that with very small quantities of gaseous medium, a constant medium environment can be created for the friction linings with regard to both the medium temperature and the medium composition, such that the same friction conditions are always present at all times.

A third aspect of the invention relates to a punch press with a clutch and brake device in accordance with the second aspect of the invention. In such machines, the advantages of the invention are particularly apparent.

### BRIEF DESCRIPTION OF THE DRAWINGS

Further preferred embodiments of the invention are apparent from the dependent claims and from the now following description with reference to the figures. Thereby show:

FIG. 1 a first punch press according to the invention in a rear view;

FIG. 2 a vertical section along the line A-A in FIG. 1;

FIG. 3 the detail X from FIG. 2;

FIG. 4 a second punch press according to the invention in a rear view;

FIG. 5 a vertical section along the line B-B in FIG. 4;

FIG. 6 the detail Y from FIG. 5;

FIG. 7 a third punch press according to the invention in a rear view;

FIG. 8 a vertical section along the line C-C in FIG. 7; and

FIG. 9 the detail Z from FIG. 8.

### DETAILED DESCRIPTION

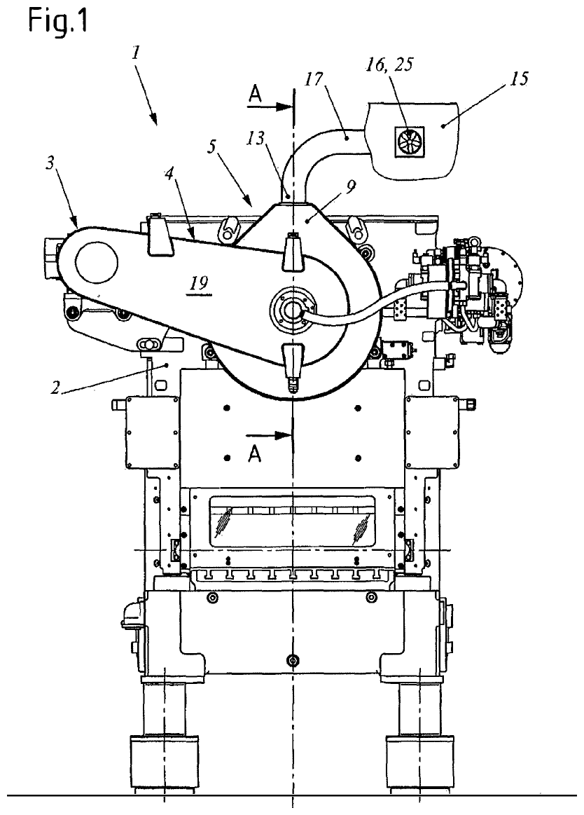

FIG. 1 shows a first punch press 1 according to the invention in the rear view. The press 1 comprises a press structure 2 with a machine table and a press ram operating against the machine table, which is driven by an electric motor 3 via a belt drive 4 and a combined clutch and brake device 5 according to the invention with flywheel 6.

The press 1 is arranged in a closed soundproofing booth, of which only a section of a side wall 15 is shown.

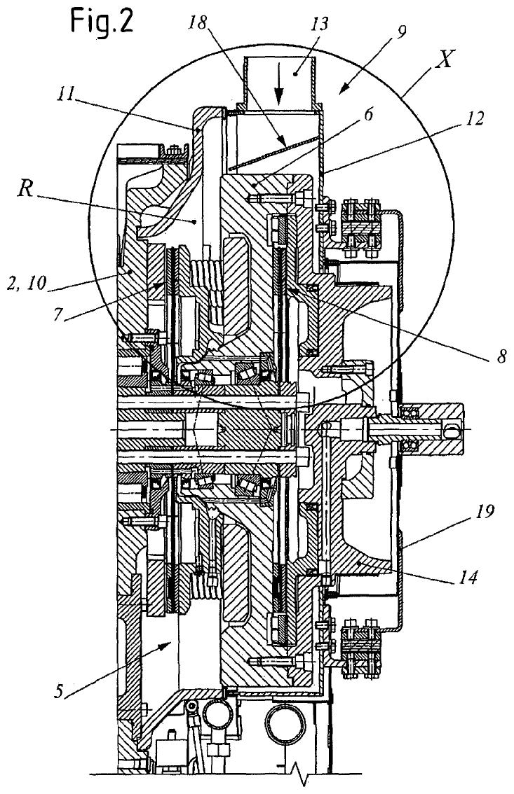

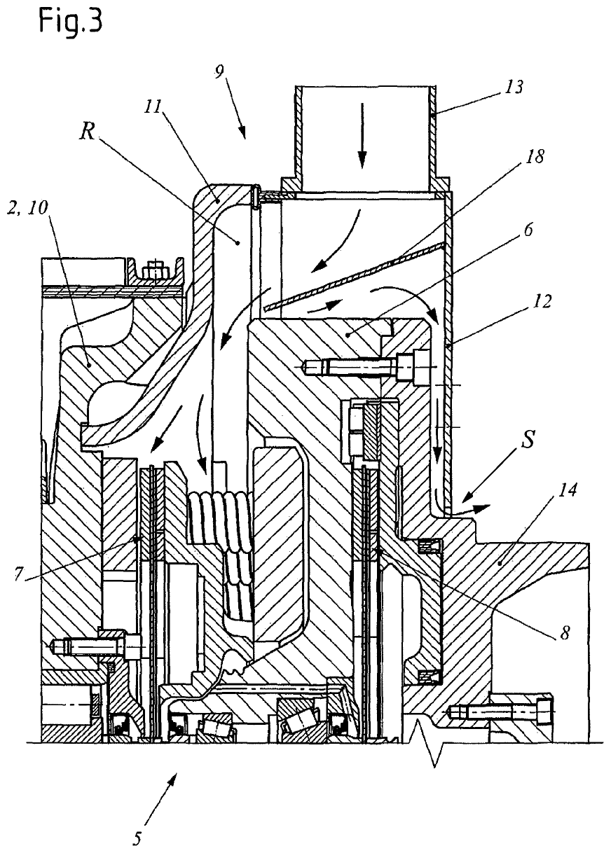

FIG. 2 shows a vertical section through the clutch and brake device 5 according to the invention. As can be seen in conjunction with FIG. 3, which shows the detail from FIG. 2 enlarged and without the belt cover 19, the flywheel 6 of the clutch and brake device 5 as well as its friction linings 7, 8 are arranged in a housing 9, the boundary walls of which are formed by the machine housing 10 of the press 1, an adjoining sealing housing 11 and a cover 12 for the flywheel 6.

The cover 12 has a supply port 13 for clean dry air on its upper side and is passed through centrally in the axial direction by the belt pulley 14 for the drive belt (not shown), thereby forming a narrow sealing gap S between the belt pulley 14 and the cover 12 (see FIG. 3). Otherwise, the housing 9 is hermetically closed and thus forms a chamber R sealed off from the environment of the punch press 1, in which the flywheel 6 together with the friction discs and the friction linings 7, 8 of both the brake group and the clutch group are arranged.

As can be seen in FIG. 1, clean and dry air is drawn in from the environment of the soundproofing booth by means of an axial fan 16 in the side wall 15 of the soundproofing booth and supplied to this chamber R via an air duct 17 and the supply port 13.

As can be seen in particular from the arrows shown in FIG. 3, it meets a deflector plate 18 there, which ensures that the main part of the air is directed into the area between the machine housing 10 and the flywheel 6, i.e. where the brake group is arranged. The air then flows around the clutch and brake device 5 and enters the belt cover 19 via the narrow sealing gap S formed between the belt pulley 14 and the cover 12, from where it flows into the direction of the drive motor 3 and then escapes into the environment. Because the sealing gap S is the only opening through which the air can escape from the chamber R, the outflowing air volume and the overpressure in the chamber R can be set via its flow cross-section and via the operating parameters of the axial fan 16.

If the air in the vicinity of the soundproofing booth is contaminated with dust, moisture and/or oil mist, the axial fan 16 is followed by devices for appropriate treatment of the air drawn in (filtering/dehumidifying/de-oiling), which the air must pass through before it is supplied to the chamber R.

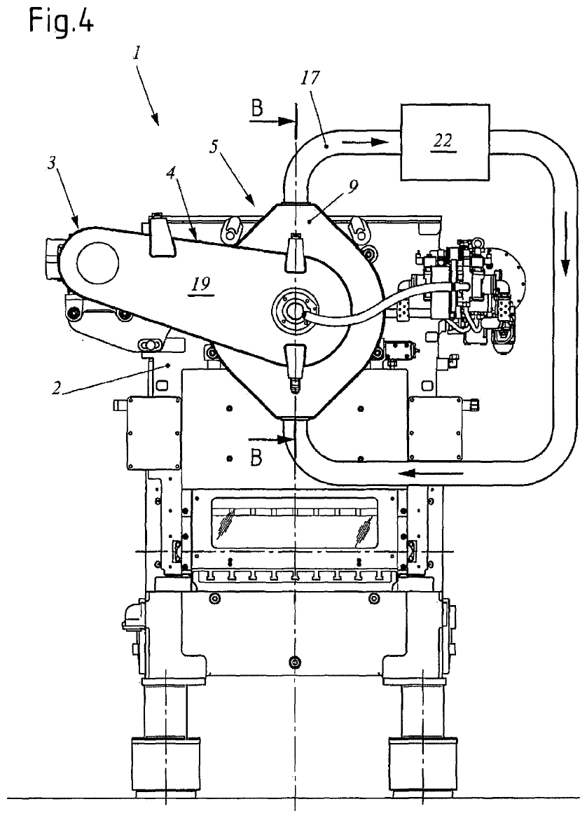

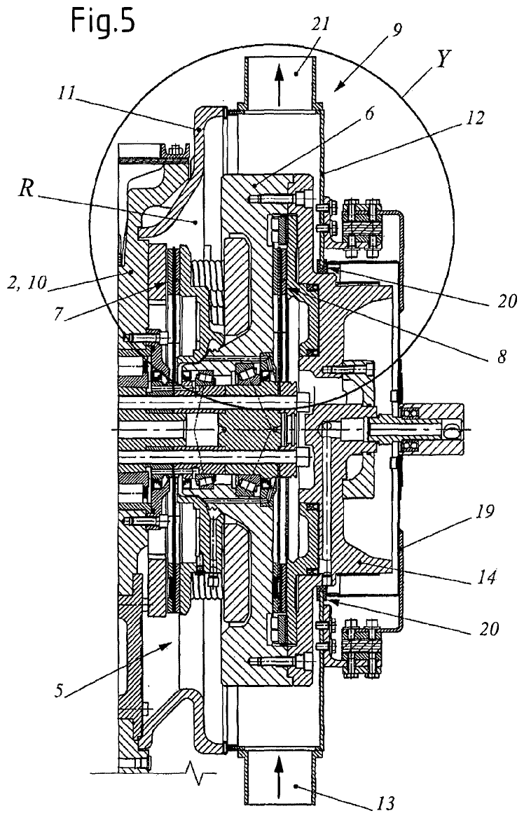

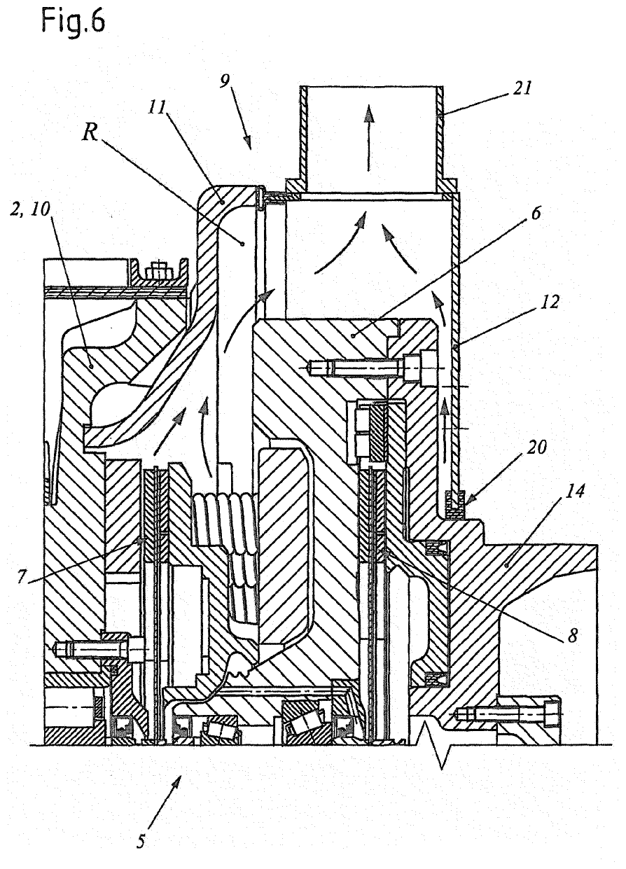

The FIGS. 4, 5 and 6 show illustrations, like the FIGS. 1, 2 and 3, of a second punch press 1 according to the invention. This differs from the one shown in the FIGS. 1 to 3 in that here, the gap between the belt pulley 14 and the cover 12 is closed with a seal 20 and the cover 12 has a connection port 21, 13 each on both its upper side and its lower side, the lower of which serves as a supply port 13 and the upper as a discharge port 21. The two connection ports 13, 21 are connected via an air duct 17, in which a cooling device 22 with a circulation fan and with a filter is arranged, which, during the intended operation, draws heated air out of the chamber R via the upper connecting piece 21, cools and filters it and then blows it back into the chamber R via the lower connection port 13. In this way, the chamber R is part of a circuit in which the air circulates during the intended operation and is cooled and filtered.

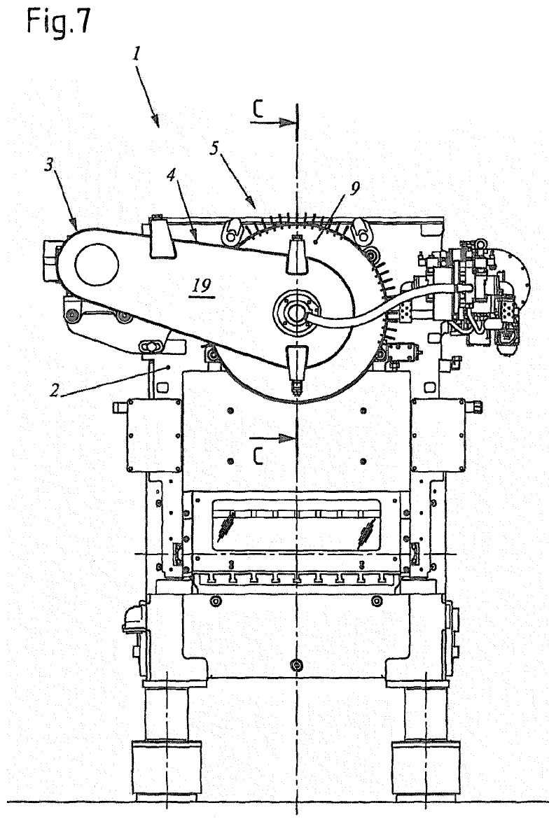

The FIGS. 7, 8 and 9 show illustrations like the FIGS. 1, 2 and 3 of a third punch press 1 according to the invention. This differs from the one shown in the FIGS. 1 to 3 in that here the gap between the belt pulley 14 and the cover 12 is closed with a seal 20 and the cover 12 has no supply port 13. The chamber R therefore has neither supply nor discharge openings and is completely sealed off from the environment of the punch press.

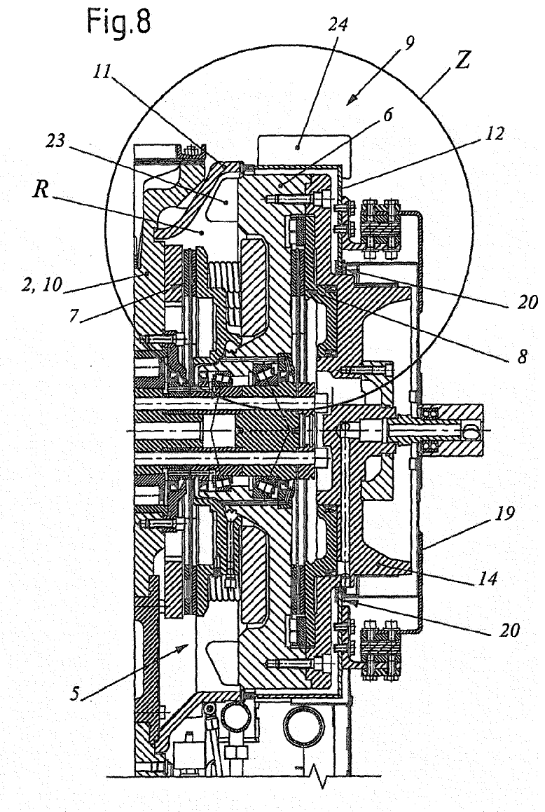

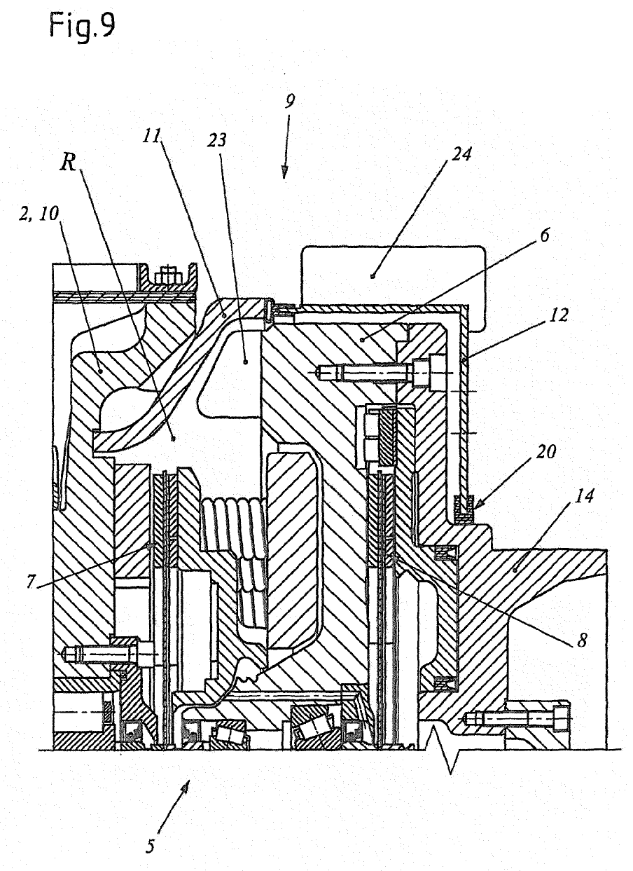

As can be seen in the FIGS. 8 and 9, here, the flywheel 6 has a large number of fan blades 23 on its side facing the brake group, which ensure that the air present in the chamber R circulates and flows along the inner wall of the cover 12, thereby dissipating heat to it. For better heat dissipation, the cover 12 has a plurality of cooling fins 24 on its outer circumference.

While preferred embodiments of the invention are described in the present application, it should be clearly noted that the invention is not limited thereto and may be carried out in other ways within the scope of the now following claims.

What is claimed is:

1. A method for operating a combined clutch and brake device of a punch press equipped with dry friction linings, wherein the friction linings are arranged in a chamber which is sealed off from the environment of the punch press and is filled with a dry and oil-free gaseous medium, in particular with dry and oil-free air.

2. Method The method according to claim 1, wherein the chamber with the gaseous medium is put under an overpressure.

3. The method according to claim 1, wherein the gaseous medium is set in motion in the chamber, in particular circulated.

4. The method according to claim 1, wherein dry and oil-free gaseous medium is supplied to the chamber and discharged from the chamber permanently, intermittently or under-specific operating conditions.

5. The method according to claim 4, wherein medium is discharged from the chamber into the environment of the punch press.

6. The method according to claim 4, wherein air is drawn in from the environment of the punch press, is cleaned, dried and/or d-oiled by means of a treatment device and is then supplied to the chamber.

7. The method according to claim 4, wherein the clutch and brake device is arranged together with the punch press in a closed soundproofing booth and air is drawn in from the environment of the soundproofing booth and supplied to the chamber.

8. The method according to claim 4, wherein the gaseous and substantially dry and oil-free medium is supplied to the chamber from a reservoir.

9. The method according to claim 4, wherein the chamber is part of a circuit in which, during the intended operation, the gaseous medium which is discharged from the chamber is subjected to a treatment and is subsequently supplied back to the chamber.

10. The method according to claim 9, wherein the gaseous medium discharged from the chamber is cooled before it is supplied back to the chamber.

11. The method according to claim 9, wherein the gaseous medium discharged from the chamber is dehumidified and/or de-oiled before it is supplied back to the chamber.

12. The method according to claim 9, wherein the gaseous medium discharged from the chamber is purified, in particular filtered, before it is supplied back into the chamber.

13. A combined clutch and brake device for carrying out the method according to claim 1, with dry friction linings for transmitting the drive and brake torques, wherein the friction linings are arranged in a chamber which is sealed off from the environment of the punch press and which is filled or can be filled with a dry and oil-free gaseous medium, in particular with dry oil-free air.

14. The clutch and brake device according to claim 13, wherein the device is designed in such a way that the chamber can be pressurized with the medium during the intended operation.

15. The clutch and brake device according to claim 13, wherein the device comprises means, in particular internal ventilation blades, with which a movement, in particular a circulation, of the gaseous medium in the chamber can be generated during the intended operation.

16. The clutch and brake device according to claim 13, wherein the chamber has supply and discharge openings via which, during the intended operation, gaseous medium can be supplied to the chamber and discharged from the chamber permanently, intermittently or under certain operating conditions.

17. The clutch and brake device according to claim 16, further comprising an air treatment device by means of which, during the intended operation of the device, air can be drawn in from the environment of the punch press, cleaned, dried and/or de-oiled and can then be supplied to the chamber.

18. The clutch and brake device according to claim 16, wherein the clutch and brake device together with the punch press is arranged in a closed soundproofing booth and devices are present by means of which, during the intended operation, air can be drawn in from the environment of the soundproofing booth and supplied to the chamber.

19. The clutch and brake device according to claim 16, further comprising a reservoir for the gaseous and substantially dry and oil-free medium from which it can be supplied into the chamber.

20. The clutch and brake device according to claim 16, wherein the chamber is part of a circuit in which the gaseous medium can be circulated during the intended operation.

21. The clutch and brake device according to claim 20, wherein means are arranged in the circuit for treating the gaseous medium circulated therein during the intended operation.

22. The clutch and brake device according to claim 21, wherein cooling means are present in the circuit for cooling the gaseous medium circulated therein during the intended operation.

23. The clutch and brake device according to claim 21, wherein dehumidifying and/or de-oiling means are present in the circuit for dehumidifying and/or de-oiling the gaseous medium circulated therein during the intended operation.

24. The clutch and brake device according to claim 21, wherein cleaning and/or filtering means are present in the circuit for cleaning and/or filtering the gaseous medium circulated therein during the intended operation.

25. A punch press with a clutch and brake device according to claim 13.
